(19) United States
(12) Patent Application Publication
(10) Pub. No.: US 2014/0362027 A1
(43) Pub. Date: Dec. 11, 2014

(54) TRANSPARENT TOUCH PANEL

(71) Applicant: ILI TECHNOLOGY CORP., Hsinchu County (TW)

(72) Inventors: Jim HSU, Hsinchu County (TW); Yunghsin YAO, Hsinchu City (TW)

(73) Assignee: ILI TECHNOLOGY CORP., Hsinchu County (TW)

(21) Appl. No.: 14/032,175

(22) Filed: Sep. 19, 2013

(30) Foreign Application Priority Data
Jun. 10, 2013 (TW) 102120502

(51) Int. Cl. G06F 3/044

(52) U.S. Cl. CPC G06F 3/044
USPC 345/174

(57) ABSTRACT

A transparent touch panel includes a transparent substrate and a transparent layer disposed on the transparent substrate. The surface of the transparent substrate has an electrode region and a wiring region. The transparent layer includes at least one touch sensitive electrode and at least one conductive wiring. The at least one touch sensitive electrode is disposed in the electrode region and has a plurality of bent slits. The at least one conductive wiring is disposed in the wiring region and electrically connected to the touch sensitive electrode and has a bent shape.

### BACKGROUND

1. Field of the Invention

The instant disclosure relates to structural arrangement of transparent touch panel, and pertains particularly to a transparent touch panel having transparent layer.

2. Description of Related Art

Touch panels are widely implemented in electronic devices as the user interface technology advances, for example, mobile phones, navigation systems, tablets, personal digital assistant (PDA), industrial control panel and the like. According to different transmitting media, touch panels are generally categorized as resistive, capacitive, optical and sonic touch panels. For example, a sensing layer made of transparent materials can be disposed in a sensing area of the substrate of a touch panel, and a human finger or a stylus can be in contact with the sensing area when in operation.

In general, in order to improve the accuracy of touch sensing, the sensing layer is required to have a low resistance value, which can be achieved by increasing the thickness of the sensing layer. However, as the thickness of the transparent sensing layer increases, the refractive index varies in the patterned sensing layer, resulting in the sensing layer highly visually recognizable by the user.

### SUMMARY OF THE INVENTION

The embodiment of the instant disclosure provides a transparent touch panel. The transparent touch panel utilizes a transparent layer including a touch sensitive electrode, which has a plurality of bent slits, and a conductive wiring, which has a bent shape. Such arrangement decrease visually recognizability of the touch sensitive electrode and conductive wiring and enables higher visually transparency of the transparent touch panel.

The transparent touch panel in accordance with the instant disclosure includes a transparent substrate and a transparent layer disposed on the transparent substrate. The surface of the transparent substrate has an electrode region and a wiring region. The transparent layer includes at least one touch sensitive electrode and at least one conductive wiring. The at least one touch sensitive electrode is disposed in the electrode region and has a plurality of bent slits. The at least one conductive wiring is disposed in the wiring region and electrically connected to the touch sensitive electrode and has a bent shape.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE DRAWINGS

The novel features believed characteristic of the invention are set forth in the appended claims. the invention itself, however, as well as a preferred mode of use, further objectives and advantages thereof, will best be understood by reference to the following detailed description of an illustrative embodiments when read in conjunction with the accompanying drawings, wherein:

FIG. 1 illustrates a plan view of a transparent touch panel in accordance with one embodiment of the instant disclosure.

FIG. 2 illustrates a partial plan view of the transparent touch panel in the section A as shown in FIG. 1.

FIG. 3 illustrates a partial plan view of the transparent touch panel in the section B as shown in FIG. 2.

FIG. 4 illustrates a partial plan view of a transparent touch panel in accordance with another embodiment of the instant disclosure.

FIG. 5 illustrates a partial plan view of a touch sensitive electrode of a transparent touch panel in the section C as shown in FIG. 2 in accordance with one embodiment of the instant disclosure.

FIG. 6 illustrates a partial plan view of a touch sensitive electrode of a transparent touch panel in accordance with another embodiment of the instant disclosure.

FIG. 7 illustrates a partial plan view of a touch sensitive electrode of a transparent touch panel in accordance with another embodiment of the instant disclosure.

FIG. 8 illustrates a partial plan view of a touch sensitive electrode of a transparent touch panel in accordance with another embodiment of the instant disclosure.

FIG. 9 illustrates a partial plan view of a touch sensitive electrode of a transparent touch panel in accordance with another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

### First Embodiment of a Transparent Touch Panel

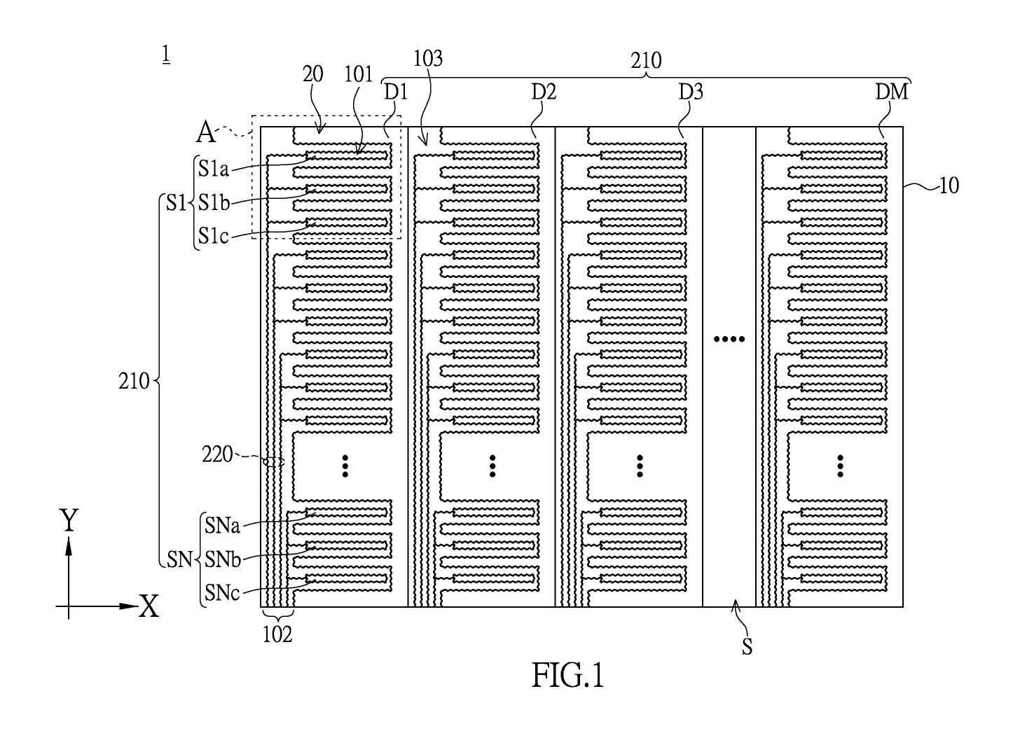

Please refer to FIG. 1, which illustrates a plan view of a transparent touch panel in accordance with one embodiment of the instant disclosure. The transparent touch panel 1 includes a transparent substrate 10 and a transparent layer 20 disposed thereon. The transparent layer 20 includes at least one touch sensitive electrode 210 and at least one conductive wiring 220. The transparent substrate 10 in the instant disclosure is a plate-shaped substrate, and the shape of the transparent substrate 10 is not limited herein. In other exemplary embodiment, the shape of the transparent substrate 10 can be film-like, cuboidal, or irregular. The transparent substrate 10 is transparent to the radiation at one or more wavelengths in the range of the spectrum. For example, the transparent substrate 10 can be formed of material such as glass, plastic, and the like, which is transparent to the radiation at one or more wavelengths in the range of the spectrum. Alternatively, the transparent substrate 10 can be formed of electrochromic glass or smart glass. In the instant embodiment, the transparent substrate 10 is visible transparent. In other exemplary embodiment, the transparent substrate 10 may be transparent to the radiation at one or more wavelengths in the range of the infrared or ultraviolet spectrum.

In addition, the transparent substrate 10 can be made of pliable material containing polyester, polycarbonate, ink, light-curing resin or optical glue such that the transparent substrate 10 is pliable. Specifically, the transparent substrate 10 can be bent, folded, or rolled, or the transparent substrate 10 can be compressed to change the shape thereof.

The plate like transparent substrate 10 has a flat top surface S, which includes an electrode region 101 and a wiring region 102 aside the electrode region 101. The touch sensitive electrode 210 is disposed in the electrode region 101, and the conductive wiring 220 is disposed in the wiring region 102. As shown in FIG. 1 in the instant embodiment, the top surface S of the transparent substrate 10 has a plurality of electrode region s 101 and a plurality of wiring regions 102, and each of the wiring regions 102 is aside each of the electrode regions 101. In the instant embodiment, the transparent touch panel 1 can be applied to a capacitive touch panel having single-layered electrode and have a plurality of touch sensitive electrodes 210, which include a plurality of driving electrodes D1˜DM and a plurality of sensing electrodes S1˜SN, wherein the number of the driving electrodes D1˜DM is M (M is a positive integer), and the number of the sensing electrodes S1˜SN is N multiplied by M (N is a positive integer). The driving electrodes D1˜DM align along a first axis (X axis) and are arranged in parallel with a second axis (Y axis).

Furthermore, the top surface S of the transparent substrate 10 has a plurality of insulating regions 103 arranged between every two of the immediately neighboring driving electrodes D1˜DM, such that every two of the immediately neighboring driving electrodes D1˜DM are electrically insulated from each other by the insulating region 103 arranged therebetween. In the instant embodiment, a bottom surface (not shown in Figures) of the plate like transparent substrate 10 opposite to the top surface S is used as a touch surface, and when a touching object such as stylus or user's finger approaching or in contact with the top surface S, a change in capacitance can be generated between the touching object and the touch sensitive electrodes 210 on the top surface S correspondingly.

As shown in FIG. 1, the driving electrodes D1˜DM respectively define sensing electrode areas, which align along the first axis (X axis). The extension direction of each of the sensing electrode areas is in parallel with the extension directions of the driving electrodes D1˜DM. An N number of sensing electrodes S1˜SN are disposed in each of the sensing electrode areas, and each of the driving electrodes D1˜DM is electrically insulated from each of the sensing electrodes S1˜SN. Furthermore, each of the sensing electrodes S1˜SN is constituted of a plurality of sensing sub-electrodes S1a˜SNa, S1b˜SNb, S1c˜SNc having the similar shapes. Alternatively, the sensing sub-electrodes SNa˜SNc of one of the sensing electrodes can have different shapes, such as round, square, rectangular, diamond, oval or pentagonal. In other words, a plurality of sensing sub-electrodes SNa˜SNc electrically connected to one another and arranged in each of the sensing electrode areas form a sensing electrode. The sensing sub-electrodes SNa˜SNc in each of the sensing electrode areas may be configured to a great variety of shapes, dimensions, and arrangement and the configuration thereof is not limited to.

To put it concretely, a transparent conductive material containing ITO (Indium Tin Oxide) can be partially deposited on the top surface S of the transparent substrate 10 to form a patterned transparent layer 20. The thickness of the transparent layer 20 for example ranges from 20 to 200 nanometers, such that the transparent layer 20 has highly transparency and better resistance uniformity. The preferred thickness of the transparent layer 20 provides higher accuracy and sharpness of the transparent touch panel 1 as well as the device using the same. Specifically, a transparent conductive material can be partially deposited in each of the electrode regions 101 to form a portion of the patterned transparent layer 20 defining the touch sensitive electrodes 210. The patterned transparent layer 20 and the touch sensitive electrodes 210 can be formed by printing, spraying, lithographing, ink jetting or the like. Conventional transparent conductive layer formation methods well known to those skilled in the art may be employed and the instant disclosure is not limited thereto.

As shown in FIG. 1, the transparent touch panel 1 in the instant embodiment includes a plurality of conductive wirings 220, which are respectively led from the sensing sub-electrodes S1a˜SNa, S1b˜SNb, S1c˜SNc. The conductive wirings 220 are for transmitting electrical signals from or to the touch sensitive electrodes 210. Similarly, a transparent conductive material such as conductive material containing ITO can be partially deposited in each of the wiring regions 102 to form a portion of the patterned transparent layer 20 defining the conductive wirings 220.

It is worth to note that, the formation of the touch sensitive electrodes 210 (the driving electrodes D1˜DM and the sensing electrodes S1˜SN) and the conductive wirings 220 may carry out at the same time by process including exposure, developing, and etching. The driving electrodes D1˜DM and the sensing electrodes S1˜SN can be made of at least one transparent conductive material selected from indium tin oxide (ITO), indium zinc oxide (IZO), antimony tin oxide (ATO), aluminum oxide and the like. The conductive wirings 220 can be made of at least one transparent conductive material selected from indium tin oxide (ITO), indium zinc oxide (IZO), antimony tin oxide (ATO), aluminum oxide and the like. In another embodiment, the conductive wirings 220 may be made of at least one metal material selected from gold, silver, copper, and the like. In addition, the insulating region 103 may have an insulating layer (not shown in Figures) formed thereon, and the insulating layer can be made of at least one transparent insulating material selected from silicon dioxide, epoxy resin, glass, polyethylene, polyimide, and the like.

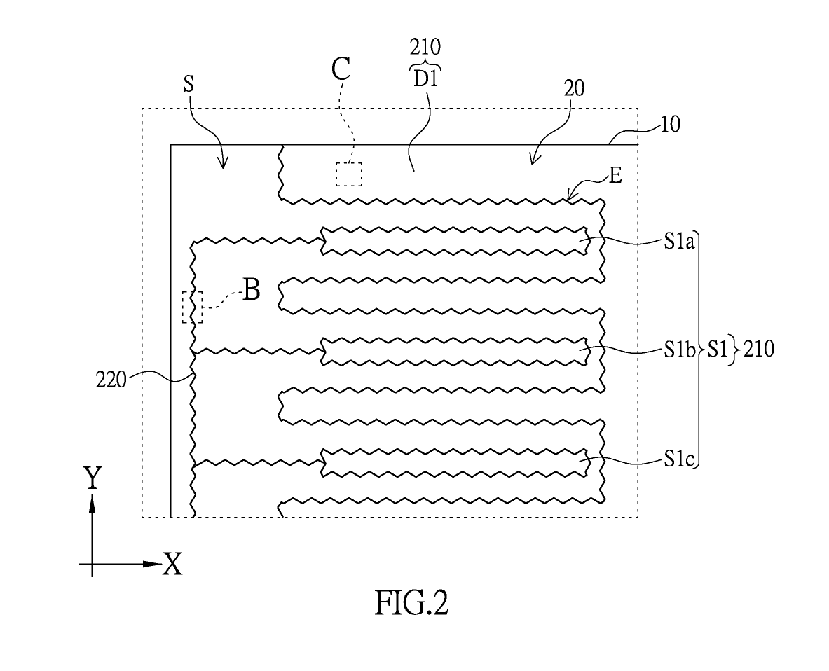

Please refer concurrently to FIG. 1 and FIG. 2, where FIG. 2 illustrates a partial plan view of the transparent touch panel in the section A as shown in FIG. 1. In the instant embodiment, each of the sensing electrodes S1˜SN is constituted of three sensing sub-electrodes SNa˜SNc having the similar rectangle like shapes. The sensing sub-electrodes SNa˜SNc are in parallel with one another. The sensing sub-electrodes SNa˜SNc arranged in each of the sensing electrode area may be configured to a great variety of numbers, and the configuration thereof is not limited to. In addition, the sensing electrodes S1˜SN or the driving electrodes D1˜DM may be configured to a great variety of numbers, and the configuration thereof is not limited to.

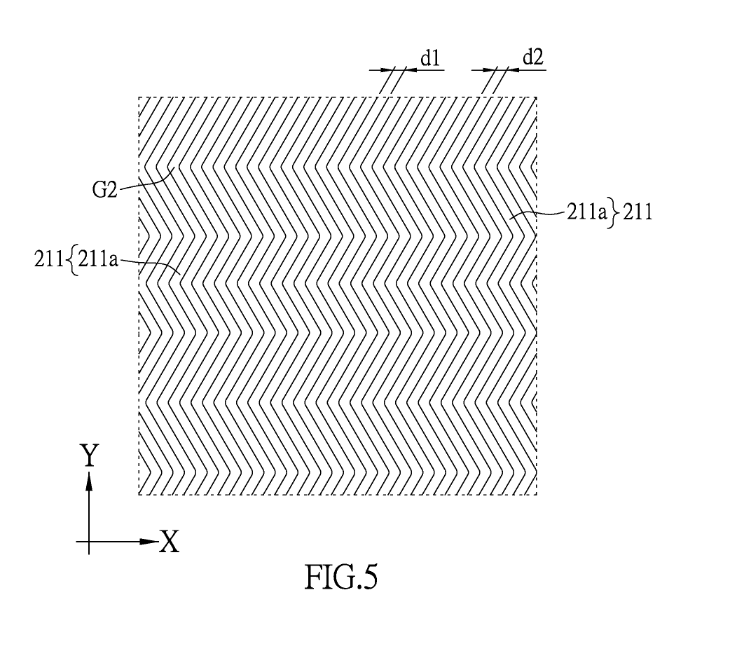

Attention is now invited to FIG. 5, which illustrates a partial plan view of a touch sensitive electrode of a transparent touch panel in the section C as shown in FIG. 2 in accordance with one embodiment of the instant disclosure. Each of the touch sensitive electrodes 210 (the driving electrodes D1˜DM and the sensing sub-electrodes) has a plurality of bent slits 211. The bent slits 211 of each of the touch sensitive electrodes 210 are arranged side by side. Specifically, the bent slits 211 of each of the touch sensitive electrodes 210 are conformingly arranged with respect to one another. Each of the bent slits 211 is formed by a plurality of v-shaped sub-slits 211a neighbored in series, and two of the v-shaped sub-slits 211a immediately neighboring with each other are inversely arranged. Each of the v-shaped sub-slits 211a defines a second angle G2, which ranges from 105 to 165 degrees.

Please refer concurrently to FIG. 2 and FIG. 5, in the instant disclosure, the extension direction of each of the bent slits 211 is in the direction of the Y axis, and the extension direction of each of the bent slits 211 is parallel to the extension direction of the driving electrodes D1˜DM. It is worth noting that, the touch sensitive electrode 210's at least one side E that is in the direction of the Y axial has a bent shape, and the bent slits 211 are conformingly arranged with respect to the touch sensitive electrode 210's sides E that is in the direction of the Y axial and has a bent shape. In the instant embodiment, the touch sensitive electrode 210's sides E can all have a bent shape, and the bent slits 211 are conformingly arranged with respect to the touch sensitive electrode 210's sides E.

As shown in FIG. 5 in the instant embodiment, the v-shaped sub-slits 211a of each of the bent slits 211 are connected in series, and each of the v-shaped sub-slits 211a has a symmetric shape. In addition, the vertexes of the second angles G2 in each of the bent slits 211 lie in an imaginary straight line, and the imaginary straight lines are in the direction of the Y axis and are perpendicular to the extension direction of the sensing sub-electrode S1a˜SNa, S1b˜SNb, S1c˜SNc. The width d1 of each of the bent slits 211 can range from 10 to 200 micrometers, and the gap d2 between two of the bent slits 211 immediately neighboring to each other can be measured from 10 to 200 micrometers. In the instant embodiment, the width d1 of the bent slits 211 are the same and substantially equal to the value of the gap d2.

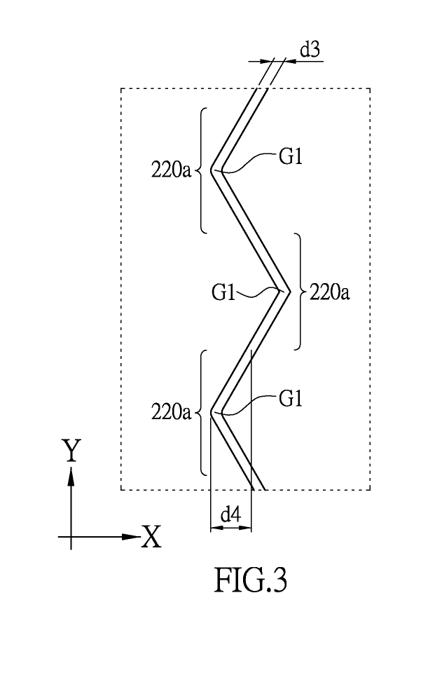

Attention is now invited to FIG. 3, which illustrates a partial plan view of the transparent touch panel in the section B as shown in FIG. 2. The conductive wiring 220 is formed by a plurality of v-shaped segments 220a connected in series, and two of the v-shaped segments 220a immediately connected to each other are inversely arranged. Each of the v-shaped segments 220a defines a first angle G1, which ranges from 105 to 165 degrees. Please refer concurrently to FIG. 2 and FIG. 3, in the instant disclosure, the vertexes of the first angles G1 in each of the conductive wirings 220 lie in an imaginary line. The width d3 of each of the conductive wirings 220 can be measured from 10 to 100 micrometers, and the height (the vertical distance between the vertex of the first angle G1 and one of the ends of the v-shaped segment 211a) of each of the v-shaped segments 220a can be measured from 10 to 100 micrometers.

According to the embodiment, the transparent touch panel 1 has the touch sensitive electrodes 210, which have a plurality of bent slits 211, and the conductive wirings 220, which have a bent shape, thereby the touch sensitive electrodes 210, the conductive wirings 220 and the patterned transparent layer 20 can be visually unrecognizable by the user. Hence, the transparent touch panel 1 is flexible and highly applicable to various applications.

### Second Embodiment of a Transparent Touch Panel

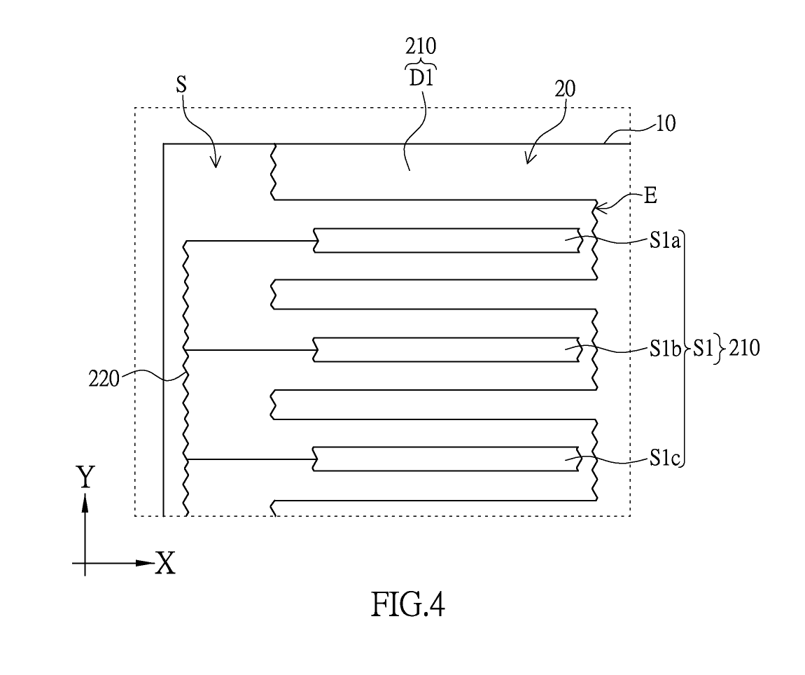

Please refer to FIG. 4, which illustrates a partial plan view of a transparent touch panel in accordance with another embodiment of the instant disclosure. The transparent touch panel 1 in the instant embodiment is similar to the aforementioned transparent touch panel 1 and the description hereinafter further explains the difference there-between. As shown in FIG. 4, only a portion of the conductive wiring 220 of the transparent touch panel 1 has a bent shape, and only the touch sensitive electrode 210's sides E that is in the Y axial have a bent shape.

### Third Embodiment of a Transparent Touch Panel 1

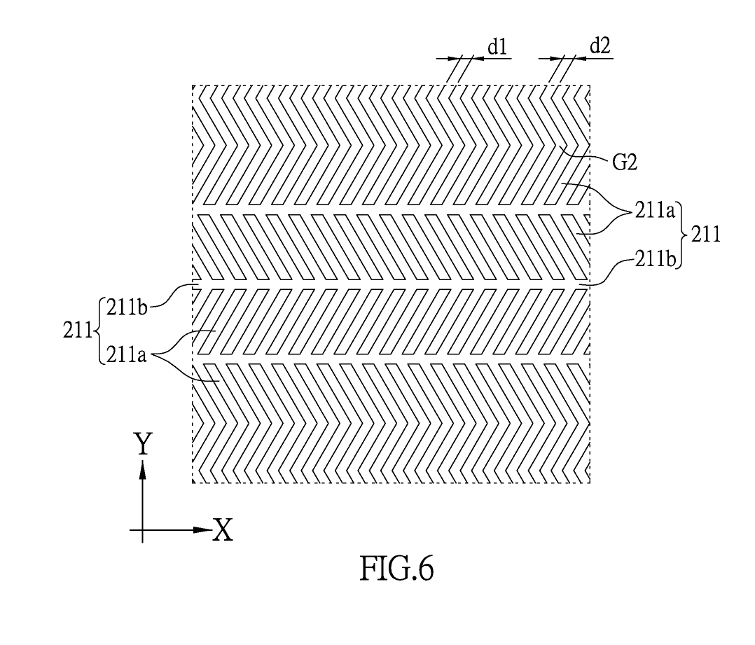

Please refer to FIG. 6, which illustrates a partial plan view of a touch sensitive electrode of a transparent touch panel in accordance with another embodiment of the instant disclosure. The transparent touch panel 1 in the instant embodiment is similar to the aforementioned transparent touch panel 1 and the description hereinafter further explains the difference there-between. As shown in FIG. 6, each of the bent slits 211 has at least one opening 211b and is discontinued by the opening 211b, and the at least one opening 211b is arranged at the vertex of one of the second angles G2. The width of each of the openings 211b can be measured from 10 to 200 micrometers.

### Fourth Embodiment of a Transparent Touch Panel 1

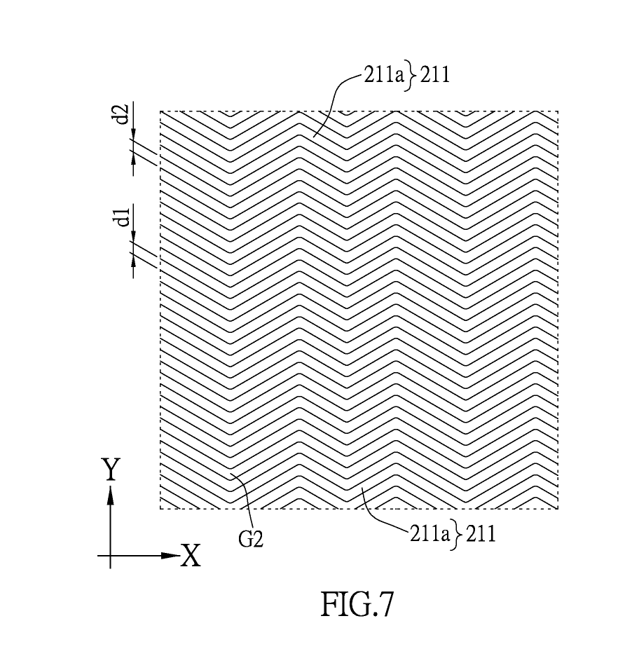

Please refer to FIG. 7, which illustrates a partial plan view of a touch sensitive electrode of a transparent touch panel in accordance with another embodiment of the instant disclosure. The transparent touch panel 1 in the instant embodiment is similar to the aforementioned transparent touch panel 1 and the description hereinafter further explains the difference there-between. As shown in FIG. 7, the extension direction of each of the bent slits 211 is in the direction of the X axis, and the extension direction of each of the bent slits 211 is parallel to the extension direction of the sensing sub-electrode. The vertexes of the second angles G2 in each of the bent slits 211 lie in an imaginary straight line, and the imaginary straight lines are in the direction of the X axis and are parallel to the extension direction of the sensing sub-electrode S1a˜SNa, S1b˜SNb, S1c˜SNc.

### Fifth Embodiment of a Transparent Touch Panel 1

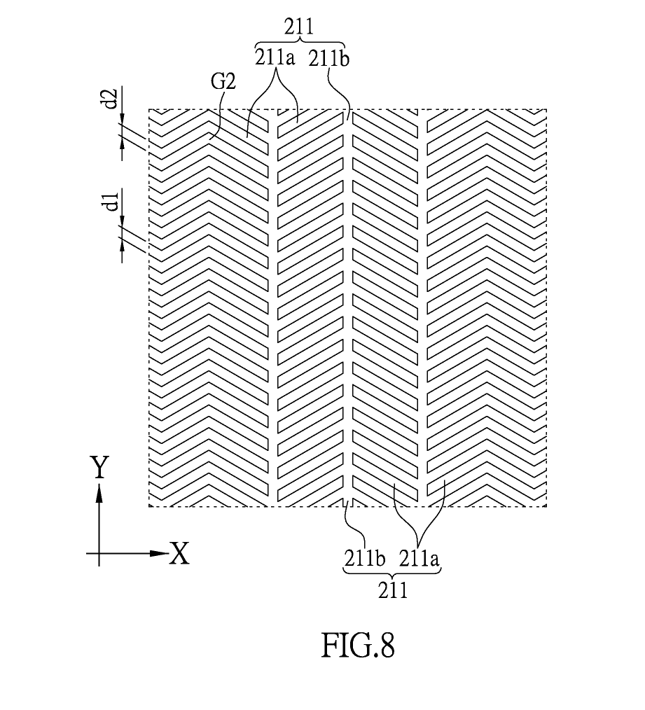

Please refer to FIG. 8, which illustrates a partial plan view of a touch sensitive electrode of a transparent touch panel in accordance with another embodiment of the instant disclosure. The transparent touch panel 1 in the instant embodiment is similar to the aforementioned transparent touch panel 1 and the description hereinafter further explains the difference there-between. As shown in FIG. 8, the extension direction of each of the bent slits 211 is in the direction of the X axis, and the extension direction of each of the bent slits 211 is parallel to the extension direction of the sensing sub-electrode S1a˜SNa, S1b˜SNb, S1c˜SNc. The vertexes of the second angles G2 in each of the bent slits 211 lie in an imaginary straight line, and the imaginary straight lines are in the direction of the X axis and are parallel to the extension direction of the sensing sub-electrode S1a˜SNa, S1b˜SNb, S1c˜SNc. In addition, each of the bent slits 211 has at least one opening 211b and is discontinued by the opening 211b, and the at least one opening 211b is arranged at the vertex of one of the second angles G2. The width of each of the opening 211bs can be measured from 10 to 200 micrometers.

### Sixth Embodiment of a Transparent Touch Panel 1

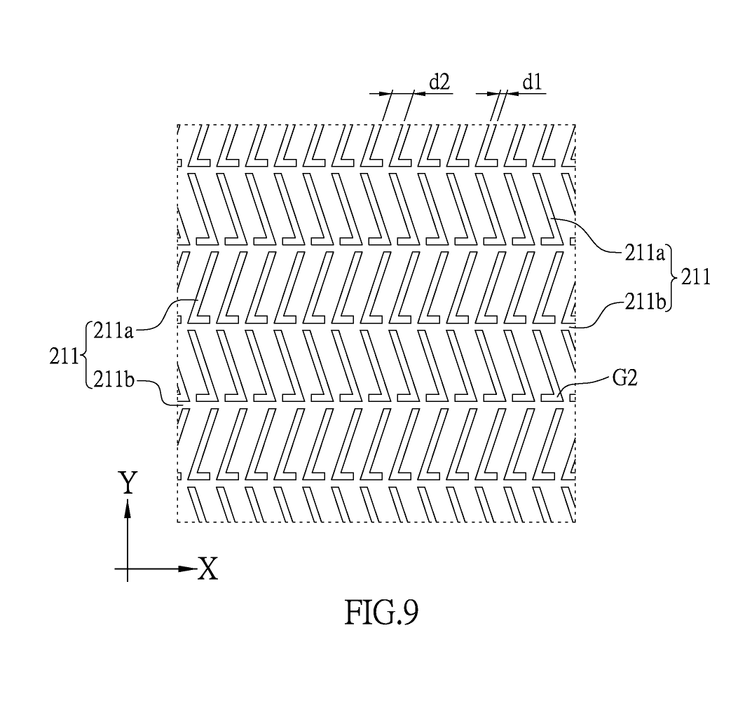

Please refer to FIG. 9, which illustrates a partial plan view of a touch sensitive electrode of a transparent touch panel in accordance with another embodiment of the instant disclosure. The transparent touch panel 1 in the instant embodiment is similar to the aforementioned transparent touch panel 1 and the description hereinafter further explains the difference there-between. As shown in FIG. 9, each of the v-shaped sub-slits 211a has an asymmetric shape, and each of the v-shaped sub-slits 211a defines a second angle G2, which ranges from 105 to 165 degrees.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A transparent touch panel, comprising:
a transparent substrate, the surface of the transparent substrate having an electrode region and a wiring region; and
a transparent layer disposed on the transparent substrate and including
at least one touch sensitive electrode disposed in the electrode region and having a plurality of bent slits; and
at least one conductive wiring disposed in the wiring region and electrically connected to the touch sensitive electrode, wherein the conductive wiring has a bent shape.

2. The transparent touch panel of claim 1, wherein the conductive wiring is formed by a plurality of v-shaped segments connected in series, and two of the v-shaped segments immediately connected to each other are inversely arranged.

3. The transparent touch panel of claim 2, wherein each of the v-shaped segments defines a first angle, which ranges from 105 to 165 degrees.

4. The transparent touch panel of claim 1, wherein the bent slits are arranged side by side.

5. The transparent touch panel of claim 4, wherein the bent slits are conformingly arranged with respect to one another.

6. The transparent touch panel of claim 5, wherein the width of each of the bent slits is measured from 10 to 200 micrometers, and the gap between two of the bent slits immediately neighboring to each other is measured from 10 to 200 micrometers.

7. The transparent touch panel of claim 1, wherein the extension direction of each of the bent slits is parallel to the extension direction of the touch sensitive electrode.

8. The transparent touch panel of claim 1, wherein each of the bent slits is formed by a plurality of v-shaped sub-slits neighbored in series, two of the v-shaped sub-slits immediately neighboring with each other are inversely arranged, and each of the v-shaped sub-slits defines a second angle, which ranges from 105 to 165 degrees.

9. The transparent touch panel of claim 8, wherein the vertexes of the second angles in each of the bent slits lie in an imaginary line.

10. The transparent touch panel of claim 9, wherein the imaginary line is parallel to the extension direction of the touch sensitive electrode.

11. The transparent touch panel of claim 8, wherein each of the v-shaped sub-slits has a symmetric shape.

12. The transparent touch panel of claim 8, wherein the v-shaped sub-slits are connected in series.

13. The transparent touch panel of claim 8, wherein each of the bent slits has at least one opening and is discontinued by the opening.

14. The transparent touch panel of claim 13, wherein the opening is arranged at the vertex of one of the second angles.

15. The transparent touch panel of claim 1, wherein a side of the touch sensitive electrode has a bent shape.

16. The transparent touch panel of claim 15, wherein the bent slits are conformingly arranged with respect to the side of the touch sensitive electrode.
